(19) United States
(12) Patent Application Publication
(10) Pub. No.: US 2023/0375196 A1
(43) Pub. Date: Nov. 23, 2023

(54) CLAMP MEMBER, CLAMP STRUCTURE, AND REFRIGERATION CYCLE DEVICE

(71) Applicant: Mitsubishi Electric Corporation, Tokyo (JP)

(72) Inventor: Tsuyoshi HAYASHI, Tokyo (JP)

(21) Appl. No.: 18/248,324

(22) PCT Filed: Feb. 3, 2021
(86) PCT No.: PCT/JP2021/003935

§ 371 Date: Apr. 7, 2023

(51) Int. Cl. F24F 1/22; F16L 3/02

(52) U.S. Cl. CPC F24F 1/22; F16L 3/02

(57) ABSTRACT

An aspect of a clamp member according to the present disclosure is a clamp member attached to an attachment portion to hold a wiring with respect to an object, wherein the attachment portion includes a pair of penetrating portions that penetrate the object in a predetermined first direction and arranged in a second direction orthogonal to the first direction to be separated from each other with a gap, wherein the clamp member includes a pair of opposing wall portions that are arranged to be separated from each other with a gap and opposite to each other in the second direction; a connecting wall portion that connects the pair of opposing wall portions; and a pair of support wall portions that protrude in a direction to be separated from the other opposing wall portion from each of the pair of opposing wall portions.

### CROSS REFERENCE TO RELATED APPLICATION

This application is a U.S. national stage application of International Application No. PCT/JP2021/003935, filed on Feb. 3, 2021, the contents of which are incorporated herein by reference.

### TECHNICAL FIELD

The present disclosure relates to a clamp member, a clamp structure, and a refrigeration cycle device.

### BACKGROUND

For example, in Patent Document 1, a clamp for an automobile wire harness in which locking claws at the front end portions of a pair of shaft portions are locked in through-holes in a vehicle body panel is disclosed.

### PATENT DOCUMENT

[Patent Document 1]
Japanese Unexamined Patent Application, First Publication No. H11-252753

In the clamp described above, there is a risk that the clamp rotates with respect to the through-hole and the orientation of the wire harness held by the clamp changes.

### SUMMARY

In view of the above circumstances, one object of the present disclosure is to provide a clamp member and a clamp structure that can suppress the change in the orientation of the wiring. Another object is to provide a refrigeration cycle device including such a clamp structure.

An aspect of a clamp member according to the present disclosure is a clamp member attached to an attachment portion to hold a wiring with respect to an object, wherein the attachment portion includes a pair of penetrating portions that penetrate the object in a predetermined first direction and arranged in a second direction orthogonal to the first direction to be separated from each other with a gap, wherein the clamp member includes a pair of opposing wall portions that are arranged to be separated from each other with a gap and opposite to each other in the second direction; a connecting wall portion that connects the pair of opposing wall portions; and a pair of support wall portions that protrude in a direction to be separated from the other opposing wall portion from each of the pair of opposing wall portions, wherein each of the pair of opposing wall portions includes a holding wall portion that protrudes to a first side in the first direction with respect to the connecting wall portion; and a sandwiching wall portion that protrudes to a second side in the first direction with respect to the connecting wall portion, the wiring is surrounded by the holding wall portions of the pair of opposing wall portions and the connecting wall portion, the sandwiching wall portions of the pair of opposing wall portions are passed through the pair of penetrating portions respectively to sandwich an intervening portion positioned between the pair of penetrating portions in the attachment portion in the second direction, and each of the sandwiching wall portions of the pair of opposing wall portions includes a claw portion that protrudes toward the sandwiching wall portion at the other side to be caught on the intervening portion from the second side, the holding wall portions of the pair of opposing wall portions are elastically displaceable in a direction to approach each other, the sandwiching wall portions of the pair of opposing wall portions elastically displace in a direction to be separated from each other when the holding wall portions of the pair of opposing wall portions are elastically displaced in the direction to approach each other, and the pair of support wall portions come into contact with the attachment portion from the first side.

An aspect of a clamp structure of the present disclosure includes the above-described clamp member and the attachment portion.

An aspect of a refrigeration cycle device of the present disclosure includes the clamp structure described above.

According to an aspect of the present disclosure, it is possible to suppress the change in the direction of the wiring held by the clamp member.

### BRIEF DESCRIPTION OF DRAWINGS

FIG. 1 is a schematic view showing a schematic configuration of a refrigeration cycle device according to a first embodiment.

FIG. 2 is a perspective view showing an outdoor unit according to the first embodiment.

FIG. 3 is a perspective view showing part of an electric component unit according to the first embodiment.

FIG. 4 is a perspective view showing a clamp structure according to the first embodiment and showing a state in which a clamp member is not attached to an attachment portion.

FIG. 5 is a cross-sectional view showing the clamp structure according to the first embodiment and showing a state in which the clamp member is attached to the attachment portion.

FIG. 6 is a cross-sectional view showing a sequence of attaching the clamp member to and detaching the claim member from the attachment portion according to the first embodiment.

FIG. 7 is a perspective view showing a clamp structure according to a second embodiment and showing a state in which a clamp member is not attached to an attachment portion.

FIG. 8 is a perspective view showing a clamp structure according to a third embodiment and showing a state in which a clamp member is attached to an attachment portion.

FIG. 9 is a perspective view showing a clamp structure according to a fourth embodiment and showing a state in which a clamp member is attached to an attachment portion.

FIG. 10 is a perspective view showing a clamp structure according to a fifth embodiment and showing a state in which a clamp member is attached to an attachment portion.

### DETAILED DESCRIPTION

Hereinafter, a clamp member, a clamp structure, and a refrigeration cycle device according to an embodiment of the present disclosure will be described with reference to the drawings. It is noted that the scope of the present disclosure is not limited to the following embodiments, and can be arbitrarily changed within the scope of the technical ideas of the present disclosure. In the drawings shown below, the scale and number of each structure may be different from the scale and number of the actual structure in order to make each configuration easier to understand.

### First Embodiment

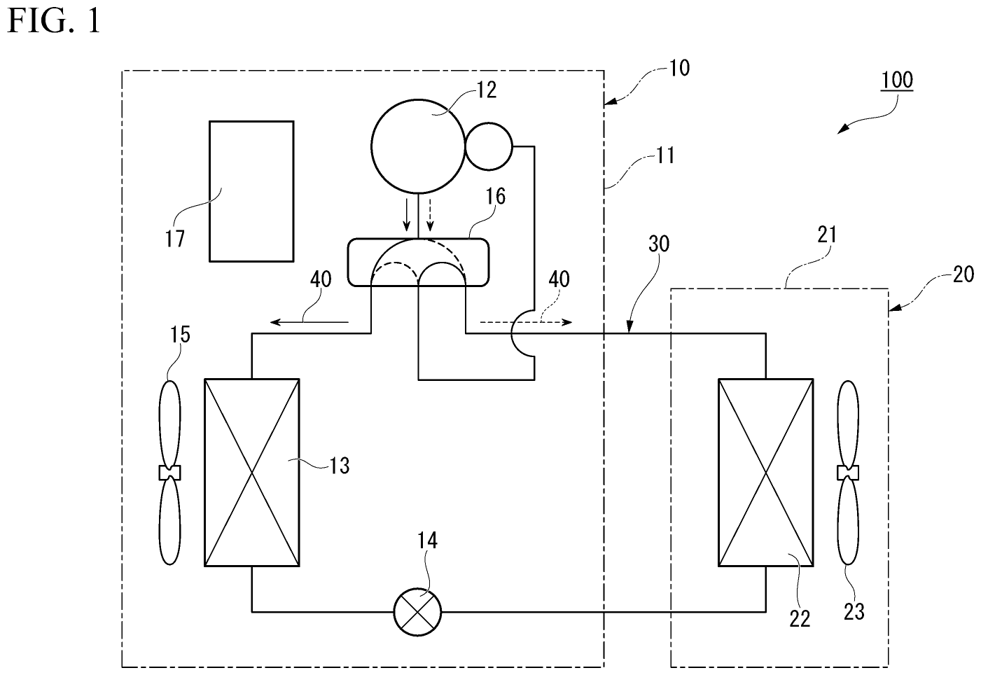

FIG. 1 is a schematic view showing a schematic configuration of a refrigeration cycle device 100 according to a first embodiment. The refrigerating cycle device 100 is a device that adopts a refrigerating cycle in which a refrigerant 40 circulates therein. The refrigeration cycle device 100 according to the first embodiment is an air conditioner. As shown in FIG. 1, the refrigeration cycle device 100 includes an outdoor unit 10, an indoor unit 20, and a circulation path portion 30. The outdoor unit 10 is arranged outdoors. The indoor unit 20 is arranged indoors. The outdoor unit 10 and the indoor unit 20 are connected to each other by the circulation path portion 30 through which the refrigerant 40 circulates.

The refrigeration cycle device 100 can adjust the temperature of the indoor air by exchanging heat between the refrigerant 40 flowing through the circulation path portion 30 and the indoor air in which the indoor unit 20 is arranged. As the refrigerant 40, for example, a fluorine-based refrigerant, a hydrocarbon-based refrigerant or the like having a low global warming potential (GWP) can be used.

The outdoor unit 10 has an outdoor unit housing 11, a compressor 12, a heat exchanger 13, a flow rate adjustment valve 14, a blower fan 15, a four-way valve 16, and electrical component unit 17. The compressor 12, the heat exchanger 13, the flow rate adjustment valve 14, the blower fan 15, the four-way valve 16, and the electrical component unit 17 are accommodated inside the outdoor unit housing 11.

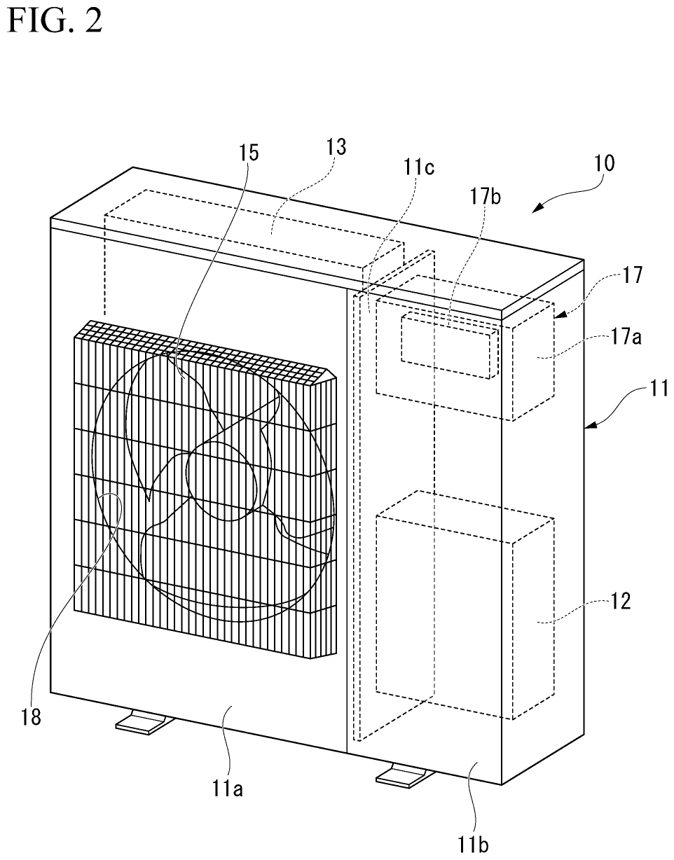

FIG. 2 is a perspective view showing the outdoor unit 10 according to the first embodiment. As shown in FIG. 2, the outdoor unit housing 11 includes a fan chamber 11a that houses the heat exchanger 13 and the blower fan 15 inside, and a machine chamber 11b that houses the compressor 12 and the electrical component unit 17 inside. The interior of the fan chamber 11a and the interior of the machine chamber 11b are separated by a partition wall portion 11c. The outdoor unit housing 11 has an air outlet port 18 that opens to the outside of the outdoor unit housing 11. The air outlet port 18 is provided at a location being opposite to the blower fan 15 in the fan chamber 11a.

As shown in FIG. 1, the compressor 12, the heat exchanger 13, the flow rate adjustment valve 14 and the four-way valve 16 are provided in a portion of the circulation path portion 30 located inside the outdoor unit housing 11. The compressor 12, the heat exchanger 13, the flow rate adjustment valve 14, and the four-way valve 16 are connected by the portion of the circulation path portion 30 located inside outdoor unit housing 11.

The compressor 12 compresses the low-pressure refrigerant 40 that has flowed into the compressor 12 to generate the high-pressure refrigerant 40. The compressor 12 may have any structure as long as the compressor 12 can compress the refrigerant 40. The compressor 12 is, for example, a displacement rotary compressor. The refrigerant 40 circulates in the circulation path portion 30 by driving the compressor 12.

The heat exchanger 13 can perform a heat exchange between the refrigerant 40 flowing inside the circulation path portion 30 and the air passing through the heat exchanger 13. The heat exchanger 13 may have any structure as long as it can perform the heat exchange between the refrigerant 40 and air.

The flow rate adjustment valve 14 can adjust the flow rate of the refrigerant 40 flowing inside the circulation path portion 30. The flow rate adjustment valve 14 is an expansion valve that reduces the pressure of the refrigerant 40 flowing inside the circulation path portion 30. The flow regulating valve 14 adjusts the flow rate of the refrigerant 40 and the pressure of the refrigerant 40 by adjusting the opening degree of thereof by the electrical component unit 17, for example. The opening degree of the flow rate adjustment valve 14 is adjusted according to the operating conditions of the indoor unit 20, for example.

The blower fan 15 generates an air flow that passes through the heat exchanger 13 and sends the air that the heat exchange with the refrigerant 40 has been performed to the outside of the outdoor unit 10. The blower fan 15 according to the first embodiment is arranged between the heat exchanger 13 and the air outlet port 18. The blower fan 15 suctions the outdoor air into the outdoor unit housing 11 from the rear side of the fan chamber 11a inside the outdoor unit housing 11. The air suctioned into the outdoor unit housing 11 passes through the heat exchanger main body 50, and the heat exchange with the refrigerant 40 is performed at that time. The blower fan 15 sends the air after the heat exchange to the outside of the outdoor unit 10 from the air outlet port 18 at the front side of the fan chamber 11a. The blower fan 15 may be any type of fan. For example, the blower fan 15 is a propeller fan.

The four-way valve 16 is provided in a portion of the circulation path portion 30 that is connected to the discharge side of the compressor 12. The four-way valve 16 can reverse the direction of the refrigerant 40 flowing through the circulation path portion 30 by switching a part of the circulation path portion 30. When the path connected by the four-way valve 16 is the path indicated by the solid line in the four-way valve 16 in FIG. 1, the refrigerant 40 flows in the circulation path portion 30 in the direction indicated by the arrowhead of the solid line as shown in FIG. 1. On the other hand, when the path connected by the four-way valve 16 is the path indicated by the dashed line in the four-way valve 16 as shown in FIG. 1, the refrigerant 40 flows in the circulation path portion 30 in the direction indicated by the arrowhead of the dashed line in FIG. 1.

The electrical component unit 17 controls each part of the outdoor unit 10. The electrical component unit 17 is, for example, a system controller that controls the entire refrigeration cycle device 100. As shown in FIG. 2, the electrical component unit 17 including a housing 17a, and a circuit board 17b accommodated in the housing 17a.

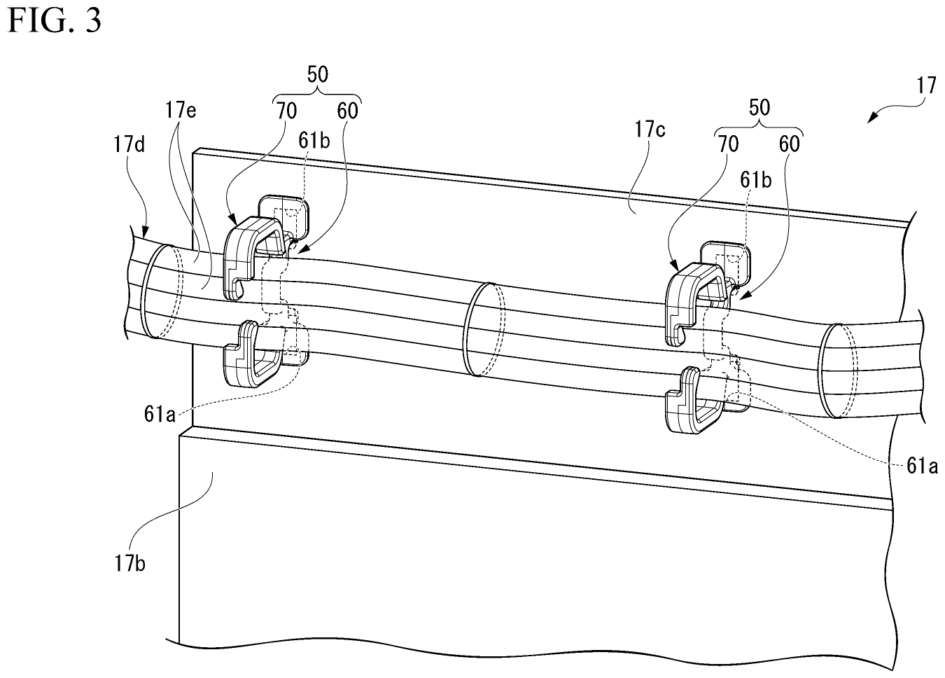

FIG. 3 is a perspective view showing part of the electrical component unit 17 according to the first embodiment. As shown in FIG. 3, the electrical component unit 17 has a plate member 17c holding a circuit board 17b and a wiring bundle 17d electrically connected to the circuit board 17b. The wiring bundle 17d is configured by bundling a plurality of wirings 17e. The wiring bundle 17d is held by the plate member 17c by a clamp structure 50, which will be described later.

In the first embodiment, the indoor unit 20 is capable of performing a cooling operation for cooling the air in the room in which the indoor unit 20 is arranged and a heating operation for warming the air in the room in which the indoor unit 20 is arranged. As shown in FIG. 1, the indoor unit 20 has an indoor unit housing 21, a heat exchanger 22 and a blower fan 23. The heat exchanger 22 and the blower fan 23 are accommodated inside the indoor unit housing 21. Although not shown in figures, the indoor unit housing 21 has an outlet port and a suction port that open into the room in which the indoor unit 20 is arranged.

The heat exchanger 22 is provided in a portion of the circulation path portion 30 located inside the indoor unit housing 21. The heat exchanger 22 performs the heat exchange between the refrigerant 40 flowing inside the circulation path portion 30 and the indoor air suctioned into the indoor unit housing 21. The heat exchanger 22 may have any structure as long as it can perform the heat exchange between the refrigerant 40 and the air inside the room. The structure of the heat exchanger 22 may be the same as the structure of the heat exchanger 13 of the outdoor unit 10 or may be different from the structure of the heat exchanger 13.

The blower fan 23 suctions the air inside the room into the indoor unit housing 21 through an air the suction port that is not shown in figures provided in the indoor unit housing 21. The air suctioned into the indoor unit housing 21 passes through the heat exchanger 22 and performs the heat exchange with the refrigerant 40 at that time. The blower fan 23 sends the air after the heat exchange to the outside of the indoor unit 20 from an outlet port that is not shown in figures provided in the indoor unit housing 21. As a result, the air that the heat exchange with the refrigerant 40 has been performed by the heat exchanger 22 is blown into the room from the outlet port. The blower fan 23 may be any type of blower. The blower fan 23 may be the same type as the blower fan 15 of the outdoor unit 10 or may be of a different type from the blower fan 15. For example, the blower fan 23 is a cross-flow fan.

When the indoor unit 20 is operated in the cooling operation, the refrigerant 40 flowing through the circulation path portion 30 flows in the direction indicated by the arrowhead of the solid line as in FIG. 1. That is, when the indoor unit 20 is operated in the cooling operation, the refrigerant 40 flowing through the circulation path portion 30 is circulated so as to flow through the compressor 12, the heat exchanger 13 of the outdoor unit 10, the flow rate adjustment valve 14, and the heat exchanger 22 of the indoor unit 20 in this sequence and then returns to the compressor 12. In the cooling operation, the heat exchanger 13 inside the outdoor unit 10 functions as a condenser, and the heat exchanger 22 inside the indoor unit 20 functions as an evaporator.

On the other hand, when the indoor unit 20 is operated in the heating operation, the refrigerant 40 flowing inside the circulation path portion 30 flows in the direction indicated by the dashed line in FIG. 1. In other words, when the indoor unit 20 is operated in the heating operation, the refrigerant 40 flowing inside the circulation path portion 30 is circulated to flow through the compressor 12, the heat exchanger 22 of the indoor unit 20, the flow rate adjustment valve 14, and the heat exchanger 13 of the outdoor unit 10 in this sequence, and then return to the compressor 12. In the heating operation, the heat exchanger 13 inside the outdoor unit 10 functions as the evaporator, and the heat exchanger 22 inside the indoor unit 20 functions as the condenser.

As shown in FIG. 3, the refrigeration cycle device 100 includes a clamp structure 50. In the first embodiment, the clamp structure 50 is provided in the electrical component unit 17. The clamp structure 50 is a structure that holds the wiring bundle 17d to the plate member 17c. In the example as shown in FIG. 3, the wiring bundle 17d is held to the plate member 17c by two clamp structures 50. The clamp structure 50 includes an attachment portion 60 provided on the plate member 17c and a clamp member 70 attached to the attachment portion 60. In the first embodiment, the plate member 17c corresponds to a target object on which the wiring 17e is held by the clamp member 70.

In the following description of the clamp structure 50, directions along the X-axis, the Y-axis, and the Z-axis appropriately shown in the drawings are defined, and each part of the clamp structure 50 is described using these directions. A direction parallel to the X-axis is called a “depth direction X”. A direction parallel to the Y-axis is called a “width direction Y”. A direction parallel to the Z-axis is called a “height direction Z”. The depth direction X, the width direction Y, and the height direction Z are directions orthogonal to each other. In the first embodiment, the height direction Z is the thickness direction of the plate member 17c. A side to which the arrowhead of the Z-axis points (+Z side) in the height direction Z is called an “upper side”, and a side opposite to the side to which the arrowhead of the Z-axis points (−Z side) in the height direction Z is called a “lower side”.

A center line CL appropriately shown in the drawing is a virtual line extending in the height direction Z through the center of the clamp structure 50 in the width direction Y and the depth direction X. In the first embodiment, the center of the clamp structure 50 in the width direction Y is the center of the attachment portion 60 in the width direction Y, and the center of the clamp member 70 in the width direction Y. In the first embodiment, the center of the clamp structure 50 in the depth direction X is the center of the attachment portion 60 in the depth direction X, and the center of the clamp member 70 in the depth direction X. In the following description, for a certain target object, the side closer to the center line CL in the width direction Y is called as “width direction inner side”, and the side farther from the center line CL in the width direction Y is called as “width direction outer side”.

In the first embodiment, the height direction Z corresponds to the “first direction”, the width direction Y corresponds to the “second direction”, and the depth direction X corresponds to the “third direction”. In the first embodiment, the upper side corresponds to the “first side” and the lower side corresponds to the “second side”. It is noted that that the depth direction X, width direction Y, and height direction Z are only names for describing the arrangement relationship of each portion, and the actual arrangement relationship is not limited by such names.

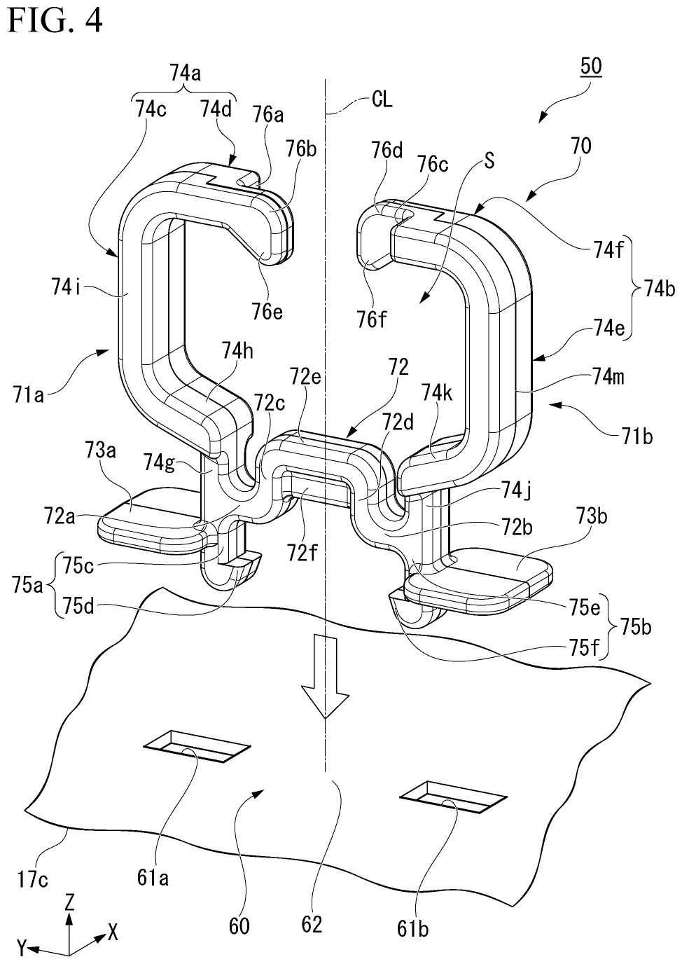

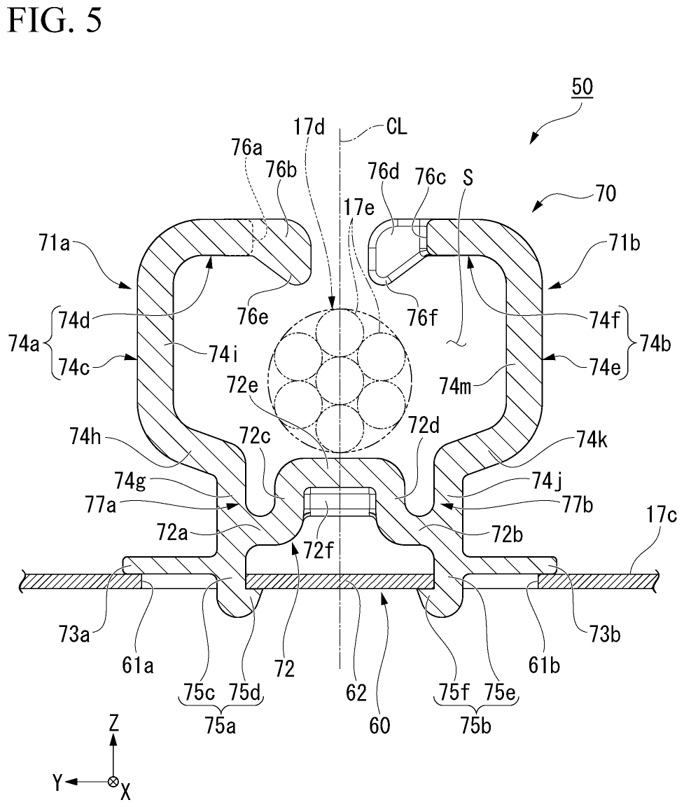

FIG. 4 is a perspective view showing the clamp structure 50 according to the first embodiment, and showing a state in which the clamp member 70 is not attached to the attachment portion 60. FIG. 5 is a cross-sectional view showing the clamp structure 50 according to the first embodiment, and showing a state in which the clamp member 70 is attached to the attachment portion 60. In the following description, unless otherwise specified, the relative positional relationship between the attachment portion 60 and the clamp member 70 will be described with respect to the state in which the clamp member 70 is attached to the attachment portion 60.

As shown in FIG. 4 and FIG. 5, the attachment portion 60 includes a pair of penetrating portions 61a, 61b and an intervening portion 62. The pair of penetrating portions 61a, 61b penetrate the plate member 17c in the height direction Z. A pair of penetrating portions 61a, 61b are arranged at intervals in the width direction Y. The penetrating portion 61a is located at on one side (+Y side) in the width direction Y with respect to the penetrating portion 61b. In the first embodiment, the pair of penetrating portions 61a, 61b are rectangular through-holes elongated in the width direction Y. The dimensions of the penetrating portion 61a and the dimensions of the penetrating portion 61b are the same with each other. The intervening portion 62 is a portion of the plate member 17c located between the pair of penetrating portions 61a, 61b in the width direction Y. In the first embodiment, the dimension of the intervening portion 62 in the width direction Y is larger than the dimensions of the penetrating portions 61a and 61b in the width direction Y.

The clamp member 70 is a member that holds the wiring 17e to the plate member 17c as a target object. In the first embodiment, the clamp member 70 holds the wiring bundle 17d, which is a bundle of a plurality of wirings 17e, on the plate member 17c. A material forming the clamp member 70 is not particularly limited. The material forming the clamp member 70 is, for example, the resin. The clamp member 70 is integrally formed by, for example, the injection molding. In the first embodiment, the clamp member 70 has a shape that is substantially symmetrical in the width direction Y. The clamp member 70 includes a pair of opposing wall portions 71a, 71b, a connecting wall portion 72 connecting the pair of opposing wall portions 71a, 71b, and a pair of support wall portions 73a, 73b protruding outward in the width direction from each of the pair of opposing wall portions 71a, 71b, respectively.

The pair of opposing wall portions 71a, 71b are arranged along the height direction Z as a whole. The pair of opposing wall portions 71a, 71b are arranged to face each other with a gap therebetween in the width direction Y. In the first embodiment, the opposing wall portion 71a and the opposing wall portion 71b are symmetrical in the width direction Y to sandwich the center line CL, except for the shapes of the tip portions of the protruding wall portions 74d, 74f, which will be described later. The opposing wall portion 71a is located on one side (+Y side) in the width direction Y with respect to the opposing wall portion 71b.

The opposing wall portion 71a has a holding wall portion 74a and a sandwiching wall portion 75a. The opposing wall portion 71b has a holding wall portion 74b and a sandwiching wall portion 75b. The holding wall portion 74a and the holding wall portion 74b are portions that protrude upward from the connecting wall portion 72. The holding wall portion 74a and the holding wall portion 74b are arranged to face each other with a gap therebetween in the width direction Y.

The holding wall portion 74a has a side wall portion 74c and the protruding wall portion 74d. The holding wall portion 74b has a side wall portion 74e and the protruding wall portion 74f. The side wall portion 74c and the side wall portion 74e are arranged along the height direction Z. The side wall portion 74c and the side wall portion 74e are arranged symmetrically in the width direction Y to sandwich the center line CL.

As shown in FIG. 5, the side wall portion 74c has an inner extending wall portion 74g, an inclined wall portion 74h, and an outer extending wall portion 74i. The inner extending wall portion 74g extends upward from an end portion in the width direction outside (+Y side) of the connecting wall portion 72. The inclined wall portion 74h extends to the width direction outside (+Y side) and diagonally upward from an end portion at the upper side of the inner extending wall portion 74g. The outer extending wall portion 74i extends upward from the end portion at the width direction outside of the inclined wall portion 74h. The outer extending wall portion 74i is located at the width direction outside of the inner extending wall portion 74g. In the first embodiment, the dimension in the height direction Z of the outer extending wall portion 74i is larger than the dimension in the height direction Z of the inner extending wall portion 74g. In the first embodiment, the end portion at the upper side of the outer extending wall portion 74i is the end portion of the side wall portion 74c at the upper side.

The side wall portion 74e has an inner extending wall portion 74j, an inclined wall portion 74k, and an outer extending wall portion 74m in the same manner as the side wall portion 74c except for being symmetrical in the width direction Y to sandwich the center line CL. Each portion of the side wall portion 74e and each portion of the side wall portion 74c are arranged to be separated from each other in the width direction Y. The gap between the outer extending wall portion 74i and the outer extending wall portion 74m in the width direction Y is larger than the gap between the inner extending wall portion 74g and the inner extending wall portion 74j in the width direction Y.

The protruding wall portion 74d protrudes from the end portion at the upper side of the side wall portion 74c toward the other holding wall portion 74b. That is, the protruding wall portion 74d protrudes to the width direction inside (−Y side) from the end portion at the upper side of the outer extending wall portion 74i. The protruding wall portion 74f protrudes from the end portion at the upper side of the side wall portion 74e toward the other holding wall portion 74a. That is, the protruding wall portion 74f protrudes to the width direction inside (+Y side) from the end portion at the upper side of the outer extending wall portion 74m. The protruding wall portion 74d and the protruding wall portion 74f face each other with a gap therebetween in the width direction Y. The gap in the width direction Y between the protruding wall portion 74d and the protruding wall portion 74f is smaller than the gap in the width direction Y between the side wall portion 74c and the side wall portion 74e. The gap in the width direction Y between the protruding wall portion 74d and the protruding wall portion 74f is smaller than the outer diameter of the wiring bundle 17d.

In the first embodiment, a first opposing portion 76a and a second opposing portion 76b are provided at a tip portion of the protruding wall portion 74d. The tip portion of the protruding wall portion 74d is the end portion at the width direction inside (−Y side) of the protruding wall portion 74d. As shown in FIG. 4, in the first embodiment, the first opposing portion 76a is a portion on one side (+X side) in the depth direction X of the end portion of the protruding wall portion 74d at the width direction inside (−Y side). In the first embodiment, the second opposing portion 76b is a portion on the other side (−X side) in the depth direction X of the end portion of the protruding wall portion 74d at the width direction inside (−Y side). The second opposing portion 76b protrudes toward the protruding wall portion 74f of the other holding wall portion 74b than the first opposing portion 76a. In other words, the end portion of the second opposing portion 76b at the width direction inside is located on the width direction inside with respect to the end portion of the first opposing portion 76a at the width direction inside. In the first embodiment, the first opposing portion 76a and the second opposing portion 76b are formed in the shape by cutting out a portion on one side (+X side) in the depth direction X of the tip portion of the protruding wall portion 74d.

In the first embodiment, a first opposing portion 76c and a second opposing portion 76d are provided at a tip portion of the protruding wall portion 74f. The tip portion of the protruding wall portion 74f is the end portion at the width direction inside (+Y side) of the protruding wall portion 74f. In the first embodiment, the first opposing portion 76c is a portion on the other side (−X side) in the depth direction X of the end portion of the protruding wall portion 74f at the width direction inside (+Y side). In the first embodiment, the second opposing portion 76d is a portion on one side (+X side) in the depth direction X of the end portion of the protruding wall portion 74f at the width direction inside (+Y side). The second opposing portion 76d protrudes toward the protruding wall portion 74d of the other holding wall portion 74a than the first opposing portion 76c. In other words, the end portion of the second opposing portion 76d at the width direction inside is located on the width direction inside with respect to the end portion of the first opposing portion 76c at the width direction inside. In the first embodiment, the first opposing portion 76c and the second opposing portion 76d are formed in the shape by cutting out a portion on the other side (−X side) in the depth direction X of the tip portion of the protruding wall portion 74f.

The arrangement of the first opposing portion 76a and the second opposing portion 76b of the protruding wall portion 74d along the depth direction X is reversed to the arrangement of the first opposing portion 76c and the second opposing portion 76d of the protruding wall portion 74f along the depth direction X. The first opposing portion 76a of the protruding wall portion 74d is opposite to the second opposing portion 76d of the protruding wall portion 74f of the other holding wall portion 74b in the width direction Y. The second opposing portion 76b of the protruding wall portion 74d is opposite to the first opposing portion 76c of the protruding wall portion 74f of the other holding wall portion 74b in the width direction Y.

The second opposing portion 76b and the second opposing portion 76d are arranged to be separated apart in the width direction Y. The distance in the width direction Y between the second opposing portion 76b and the second opposing portion 76d is smaller than the distance in the width direction Y between the first opposing portion 76a and the second opposing portion 76d, and the distance in the width direction Y between the first opposing portion 76c and the second opposing portion 76b. The distance in the width direction Y between the second opposing portion 76b and the second opposing portion 76d, the distance in the width direction Y between the first opposing portion 76a and the second opposing portion 76d, and the distance in the width direction Y between the first opposing portion 76c and the second opposing portion 76b are smaller than the outer diameter of the wiring bundle 17d. The distance in the width direction Y between the first opposing portion 76a and the second opposing portion 76d is the same as the distance in the width direction Y between the first opposing portion 76c and the second opposing portion 76b.

In the first embodiment, a protruding portion 76e protruding downward is provided at the tip portion of the protruding wall portion 74d. A protruding portion 76f protruding downward is provided at the tip portion of the protruding wall portion 74f. The protruding portion 76e is provided on the second opposing portion 76b. The protruding portion 76f is provided on the second opposing portion 76d. The protruding portions 76e, 76f have a downward protrusion height that increases as toward the width direction inside respectively. In the first embodiment, the protruding portions 76e, 76f are substantially triangular in shape with rounded corners on the lower side when viewed in the depth direction X. By providing the protruding portions 76e, 76f, the second opposing portions 76b, 76d protrude toward the lower side than the first opposing portions 76a, 76c.

The dimensions of the protruding wall portions 74d, 74f in the depth direction X, the dimensions of the outer extending wall portions 74i, 74m in the depth direction X, and dimensions of the inclined wall portions 74h, 74k in the depth direction X are larger than the dimensions of the inner extending wall portions 74g, 74j in the depth direction X. The protruding wall portions 74d, 74f, the outer extending wall portions 74i, 74m, and the inclined wall portions 74h, 74k protrude to both sides in the depth direction X than the inner extending wall portions 74g, 74j.

The sandwiching wall portion 75a and the sandwiching wall portion 75b are portions that protrude downward than the connecting wall portion 72. The sandwiching wall portion 75a and the sandwiching wall portion 75b are arranged to be opposite each other with a gap therebetween in the width direction Y. As shown in FIG. 5, the sandwiching wall portion 75a is passed through the penetrating portion 61a in the height direction Z from the upper side. The sandwiching wall portion 75b is passed through the penetrating portion 61b in the height direction Z from the upper side. That is, the holding wall portions 75a, 75b of the pair of opposing wall portions 71a, 71b are passed through the pair of penetrating portions 61a, 61b, respectively. The sandwiching wall portions 75a, 75b of the pair of opposing wall portions 71a, 71b sandwich the intervening portion 62 of the attachment portion 60 that is located between the pair of penetrating portions 61a, 61b in the width direction Y.

The sandwiching wall portion 75a has a sandwiching wall portion main body 75c and a claw portion 75d. The sandwiching wall portion 75b has a sandwiching wall portion main body 75e and a claw portion 75f. The sandwiching wall portion main body 75c extends downward from the inner extending wall portion 74g. The sandwiching wall portion main body 75e extends downward from the inner extending wall portion 74j. As shown in FIG. 4, in the first embodiment, the dimensions in the depth direction X of the sandwiching wall portion main bodies 75c, 75e are the same as the dimensions in the depth direction X of the inner extending wall portions 74g, 74j. The dimensions in the depth direction X of the sandwiching wall portion main bodies 75c, 75e are slightly smaller than the dimensions in the depth direction X of the penetrating portions 61a, 61b. A square-shaped columnar portion extending downward from the end portion at the width direction inside (−Y side) of the inclined wall portion 74h is formed by the inner extending wall portion 74g and the sandwiching wall portion main body 75c. A square-shaped columnar portion extending downward from the end portion at the width direction inside (+Y side) of the inclined wall portion 74k is formed by the inner extending wall portion 74j and the sandwiching wall portion main body 75e.

As shown in FIG. 5, the sandwiching wall main body 75c is passed through the penetrating portion 61a in the height direction Z. The side surface at the width direction inside (−Y side) of the sandwiching wall main body 75c is in contact with the surface of the inner surface of the penetrating portion 61a at the width direction inside (−Y side). The sandwiching wall main body 75e is passed through the penetrating portion 61b in the height direction Z. The side surface at the width direction inside (+Y side) of the sandwiching wall main body 75e is in contact with the surface of the inner surface of the penetrating portion 61b at the width direction inside (+Y side). At least one of the sandwiching wall main body 75c and the sandwiching wall main body 75e may not have to be in contact with the inner surfaces of the penetrating portions 61a, 61b.

The claw portion 75d protrudes to the width direction inside (−Y side) from the end portion at the lower side of the sandwiching wall main body 75c. That is, the claw portion 75d protrudes toward the other sandwiching wall portion 75b. The claw portion 75f protrudes to the width direction inside (+Y side) from the end portion at the lower side of the sandwiching wall main body 75e. That is, the claw portion 75f protrudes toward the other sandwiching wall portion 75a.

The claw portions 75d, 75f are positioned at the lower side of the attachment portion 60. The claw portions 75d, 75f are hooked on the intervening portion 62 from the lower side. The surfaces at the upper side of the claw portions 75d, 75f are flat surfaces perpendicular to the height direction Z. The surfaces at the upper side of the claw portions 75d, 75f are in contact with the surface at the lower side of the intervening portion 62. More specifically, the surface at the upper side of the claw portion 75d is in contact with the edge portion of the surface at the lower side of the intervening portion 62 located on the width direction inside (−Y side) of the penetrating portion 61a. The surface at the upper side of the claw portion 75f is in contact with the edge portion of the surface at the lower side of the intervening portion 62 located on the width direction inside (+Y side) of the penetrating portion 61b.

The connecting wall portion 72 extends in the width direction Y as a whole and connects the opposing wall portion 71a and the opposing wall portion 71b. More specifically, the connecting wall portion 72 connects the connecting portion of the holding wall portion 74a and the sandwiching wall portion 75a of the opposing wall portion 71a with the connecting portion of the holding wall portion 74b and the sandwiching wall portion 75b of the opposing wall portion 71b in the width direction Y. The connecting wall portion 72 is positioned at the lower side of the wiring bundle 17d held by the clamp member 70. Thus, the clamp member 70 surrounds the wire bundle 17d, that is, the plurality of wirings 17e, by each of the holding wall portions 74a, 74b of the pair of opposing wall portions 71a, 71b and the connecting wall portion 72. In the following description, the inner space surrounded by the pair of holding wall portions 74a, 74b and the connecting wall portion 72 may be referred to as a holding space S.

In the first embodiment, the connecting wall portion 72 has a pair of width direction outside end portions 72a, 72b, a pair of bending portions 72c, 72d, a central portion 72e, and a rib portion 72f. The width direction outside end portion 72a extends to the width direction inside (−Y side) from the opposing wall portion 71a. The width direction outside end portion 72b extends to the width direction inside (+Y side) from the opposing wall portion 71b. The bending portion 72c bends and extends upward from the end portion at the width direction inside (−Y side) of the width direction outside end portion 72a. The bending portion 72d bends and extends upward from the end portion at the width direction inside (+Y side) of the width direction outside end portion 72b. The central portion 72e extends in the width direction Y. The central portion 72e connects the end portion at the upper side of the bending portion 72c and the end portion at the upper side of the bending portion 72d. In the first embodiment, the end portion at the upper end of the central portion 72e is located at the lower side of the end portion at the upper side of the inclined wall portions 74h, 74k. The rib portion 72f is positioned between the bending portion 72c and the bending portion 72d in the width direction Y. The rib portion 72f extends in the width direction Y. The end portion at the upper side of the rib portion 72f connects the bent portion 72c and the bent portion 72d in the width direction Y. The end portion at the upper side of the rib portion 72f is connected to the end portion at the lower side of the central portion 72e. The end portion at the lower side of the rib portion 72f is positioned at the upper side of the end portions at the lower side of the width direction outside end portions 72a, 72b.

As shown in FIG. 4, in the first embodiment, the dimensions in the depth direction X of the pair of width direction outside end portions 72a, 72b, the dimensions in the depth direction X of the pair of bending portions 72c, 72d, and the dimensions in the depth direction X of the central portion 72e are the same as the dimensions in the depth direction X of the inner extending wall portions 74g, 74j and the dimensions in the depth direction X of the sandwiching wall portion bodies 75c, 75e. The dimension in the depth direction X of the rib portion 72f is smaller than the dimensions in the depth direction X of the pair of width direction outside end portions 72a, 72b, the dimensions in the depth direction X of the pair of bending portions 72c, 72d, and the dimension in the depth direction X of the central portion 72e.

The support wall portion 73a protrudes to the width direction outside (+Y side) from the sandwiching wall portion main body 75c of the opposing wall portion 71a. The support wall portion 73b protrudes to the width direction outside (−Y side) from the sandwiching wall portion main body 75e of the opposing wall portion 71b. That is, the pair of support wall portions 73a, 73b protrude from either of the pair of opposing wall portions 71a, 71b in a direction separated away from the other opposing wall portion 71a, 71b. The pair of support wall portions 73a, 73b are positioned at the lower side of the connecting wall portion 72. In the first embodiment, the support wall portions 73a, 73b have a substantially square plate shape extending along the width direction Y and the depth direction X. The support wall portions 73a, 73b protrude to both sides in the depth direction X from the opposing wall portions 71a, 71b, respectively. The support wall portion 73a protrudes to the width direction outside (+Y side) than the holding wall portion 74a. The support wall portion 73b protrudes to the width direction outside (−Y side) than the holding wall portion 74b.

As shown in FIG. 5, the pair of support wall portions 73a, 73b are in contact with the attachment portion 60 from the upper side. More specifically, the support wall portion 73a is in contact with the edge portion of the penetrating portion 61a positioned at the width direction outside (+Y side) and each edge portion positioned on both sides of the attachment portion 60 in the depth direction X of the surface at the upper side of the attachment portion 60 from the upper side. The support wall portion 73b is in contact with the edge portion of the penetrating portion 61a positioned at the width direction outside (−Y side) and each edge portion positioned on both sides of the attachment portion 60 in the depth direction X of the surface at the upper side of the attachment portion 60 from the upper side. In the first embodiment, the distance in the height direction Z between the surfaces at the lower side of the support wall portions 73a, 73b and the surfaces at the upper side of the claw portions 75d, 75f is the same as the dimension of the plate member 17c in the height direction Z, that is, the thickness of the plate member 17c.

In the first embodiment, the pair of support wall portions 73a, 73b are in contact with the attachment portion 60 from the upper side and the pair of claw portions 75d, 75f are in contact with the attachment portion 60 from the lower side such that the position of the clamp member 70 with respect to the attachment portion 60 in the height direction Z is determined. Among the pair of support wall portions 73a, 73b and the pair of claw portions 75d, 75f, one or more than one portions may not be in contact with the attachment portion 60. Also, for example, in a case in which each of the pair of support wall portions 73a, 73b and the pair of claw portions 75d, 75f is in contact with the attachment portion 60, for example, the support wall portions 73a, 73b may be elastically deformed in the height direction Z.

The pair of support wall portions 73a, 73b cover at least a portion of each of the pair of penetrating portions 61a, 61b from the upper side. In the first embodiment, the support wall portion 73a covers the entire portion positioned at the width direction outside (+Y side) than a portion of the penetrating portion 61a where the sandwiching wall portion 75a is passed through from the upper side. In the first embodiment, the support wall portion 73b covers the entire portion positioned at the width direction outside (−Y side) than a portion of the penetrating portion 61b where the sandwiching wall portion 75a is passed through from the upper side.

In the first embodiment, the clamp member 70 further includes a plurality of spring portions 77a, 77b that are elastically deformable in the width direction Y. At least part of the spring portions 77a, 77b is provided on the connecting wall portion 72. In the first embodiment, the spring portion 77a is configured by part of the connecting wall portion 72 and part of the opposing wall portion 71a as one of the pair of opposing wall portions 71a, 71b. More specifically, the spring portion 77a is configured of the inner extending wall portion 74g, the width direction outside end portion 72a, and the bending portion 72c. In the first embodiment, the spring portion 77b is configured by part of the connecting wall portion 72 and part of the other opposing wall portion 71b as the other of the pair of opposing wall portions 71a, 71b. More specifically, the spring portion 77b is configured of the inner extending wall portion 74j, the width direction outside end portion 72b, and the bending portion 72d. The spring portions 77a, 77b have a U-shape opening upward when viewed in the depth direction X. The spring portion 77a and the spring portion 77b are arranged to be separated apart in the width direction Y. In the first embodiment, the spring portion 77a and the spring portion 77b are connected in the width direction Y by the central portion 72e and the rib portion 72f.

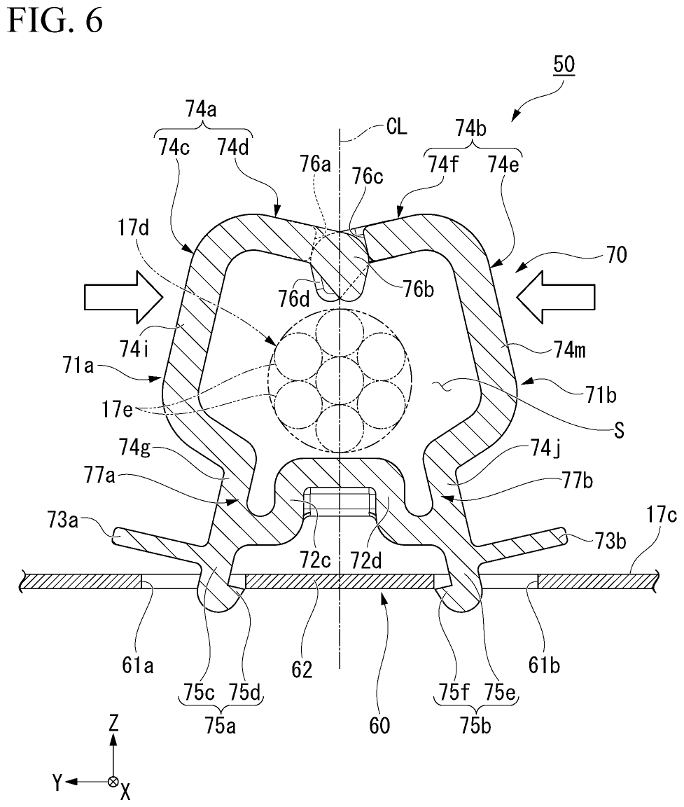

FIG. 6 is a cross-sectional view for explaining the procedure for attaching and detaching the clamp member 70 to and from the attachment portion 60. As shown in FIG. 6, the holding wall portions 74a, 74b of the pair of opposing wall portions 71a, 71b can be elastically displaceable in the direction to approach each other. The sandwiching wall portions 75a, 75b of the pair of opposing wall portions 71a, 71b elastically displace away from each other when the holding wall portions 74a, 74b of the pair of opposing wall portions 71a, 71b are elastically displaced in the direction to approach each other. More specifically, the holding wall portions 74a, 74b are elastically displaced in a direction inclined with the width direction inside with the portion connected by the connecting wall portion 72 as a fulcrum. The sandwiching wall portions 75a, 75b are elastically displaced in a direction inclined with the width direction outside with the portion connected by the connecting wall portion 72 as a fulcrum.

In a state in which the holding wall portions 74a, 74b are elastically displaced in the direction to approach each other, the U-shaped spring portions 77a, 77b are elastically deformed in the width direction Y in a direction to close the U-shaped opening. In other words, in the state in which the holding wall portions 74a, 74b are elastically displaced in the direction to approach each other, the spring portions 77a, 77b are elastically deformed in the direction in which the inner extending wall portions 74g, 74j and the bending portions 72c, 72d approach toward each other in the width direction Y. In a state in which the holding wall portions 74a, 74b are elastically displaced in the direction to approach each other, the support wall portions 73a, 73b are elastically displaced in the width direction Y to be separated away from each other.

The holding wall portions 74a, 74b are elastically displaceable in the width direction inside until the first opposing portion 76a of the holding wall portion 74a and the second opposing portion 76d of the holding wall portion 74b are in contact with each other, and the first opposing portion 76c of the holding wall portion 74b and the second opposing portion 76b of the holding wall portion 74a are in contact with each other. In the state in which the first opposing portion 76a and the second opposing portion 76d are in contact, and the first opposing portion 76c and the second opposing portion 76b are in contact, the claw portions 75d, 75f of the sandwiching wall portions 75a, 75b are in a state of being separated in the width direction Y to have a gap equal to or more than the dimension of the intervening portion 62 in the width direction Y.

An operator who attaches the clamp member 70 to the attachment portion 60 applies a force in the width direction inside, as indicated in the arrowhead shown in FIG. 6, with respect to the outer extending wall portions 74i, 74m of the holding wall portions 74a, 74b to make the holding wall portions 74a, 74b to be elastically displaced in a direction inclined with the width direction inside until the first opposing portions 76a, 76c and the second opposing portions 76b, 76d of the holding wall portions 74a, 74b are in contact with each other. At this time, for example, the operator pinches the pair of holding wall portions 74a, 74b of the clamp member 70 in the width direction Y with fingers to elastically displace the pair of holding wall portions 74a, 74b. The operator inserts the pair of sandwiching wall portions 75a, 75b into the pair of penetrating portions 61a, 61b from the upper side while maintaining the pair of holding wall portions 74a, 74b to be elastically displaced. At this time, the operator inserts the sandwiching wall portions 75a, 75b into the penetrating portions 61a, 61b until the pair of support wall portions 73a, 73b come into contact with the surface at the upper side of the attachment portion 60. After inserting the sandwiching wall portions 75a, 75b into the penetrating portions 61a, 61b, the operator releases the force applied to the holding wall portions 74a, 74b. As a result, the holding wall portions 74a, 74b and the sandwiching wall portions 75a, 75b are displaced to restore, and the claw portions 75d, 75f are caught by the intervening portion 62 from the lower side. Thus, the clamp member 70 is attached to the attachment portion 60.

On the other hand, the operator who detaches the clamp member 70 from the attachment portion 60 applies a force to the clamp member 70 in the same manner as when attaching the clamp member 70 to the attachment portion 60 to open the pair of sandwiching wall portions 75a, 75b in the width direction outside. As a result, it is possible for the operator to pull out the pair of sandwiching wall portions 75a, 75b in the upper side from the pair of penetrating portions 61a, 61b, respectively, and it is possible to detach the clamp member 70 from the attachment portion 60.

Also, for example, the operator holding the wiring bundle 17d on the clamp member 70 pushes the wiring bundle 17d into the gap between the protruding wall portions 74d, 74f to arrange the wiring bundle 17d in the holding space S. When the wiring bundle 17d is pushed into the gap between the protruding wall portions 74d, 74f, the holding wall portions 74a, 74b are elastically displaced in the direction separating from each other, that is, the width direction outside. The operation of holding the wiring bundle 17d on the clamp member 70 may be performed before the clamp member 70 is attached to the attachment portion 60 or may be performed after the clamp member 70 is attached to the attachment portion 60.

According to the first embodiment, the pair of opposing wall portions 71a, 71b have the holding wall portions 74a, 74b and the sandwiching wall portions 75a, 75b, respectively. The sandwiching wall portions 75a, 75b of the pair of opposing wall portions 71a, 71b are passed through the pair of penetrating portions 61a, 61b, respectively, to sandwich the intervening portion 62 positioned between the pair of penetrating portions 61a, 61b of the attachment portion 60 in the width direction Y. Therefore, in a state in which the clamp member 70 is attached to the attachment portion 60, the pair of sandwiching wall portions 75a, 75b are caught in the depth direction X with respect to the pair of penetrating portions 61a, 61b, respectively, and it is possible to suppress the clamp member 70 from rotating around the axis along in the height direction Z with respect to the attachment portion 60. Accordingly, it is possible to prevent the wire bundle 17d held by the clamp member 70, that is, the plurality of wires 17e, from changing in orientation. Therefore, it is possible to prevent the wiring 17e from coming into contact with other components.

Further, according to the first embodiment, the holding wall portions 74a, 74b of the pair of opposing wall portions 71a, 71b are elastically displaceable in the direction to approach each other. The sandwiching wall portions 75a, 75b of the pair of opposing wall portions 71a, 71b are elastically displaced in the direction of separating from each other when the holding wall portions 74a, 74b of the pair of opposing wall portions 71a, 71b are elastically displaced in the direction to approach each other. Therefore, by elastically displacing the holding wall portions 74a, 74b in the width direction inside, the clamp member 70 can be easily attached to and detached from the attachment portion 60 as described above.

Also, as described above, it is possible to perform the attachment and the detachment of the clamp member 70 by elastically displacing the holding wall portions 74a, 74b protruding to the upper side than the connecting wall portion 72 in the width direction inside. Therefore, when attaching and detaching the clamp member 70, it is easy to visually recognize the portion where the force is applied to the clamp member 70. As a result, the workability of attaching and detaching the clamp member 70 can be improved. Also, when attaching and detaching the clamp member 70 to and from the attachment portion 60, it is unnecessary to apply the force to the wiring 17e, and it is unnecessary to touch the wiring 17e. Therefore, even if the clamp member 70 is attached to and detached from the attachment portion 60, it is possible to suppress the load from being applied to the wiring 17e.

Also, in a case in which the wire 17e held by the clamp member 70 moves within the holding space S surrounded by the pair of holding wall portions 74a, 74b and the connecting wall portion 72, it is considerable that at least one of the holding wall portions 74a, 74b is elastically displaced in the width direction outside by the wire 17e. In contrast, according to the first embodiment, as described above, in order to detach the clamp member 70 from the attachment portion 60, it is necessary to elastically displace the pair of holding wall portions 74a, 74b in the width direction inside. In other words, without elastically displacing the holding wall portions 74a, 74b in a direction different from the direction in which the holding wall portions 74a, 74b are possible to elastically displace since the wiring 17e moves, it is impossible to detach the clamp member 70 from the attachment portion 60. Therefore, even if the wiring 17e is pulled or the like and the holding wall portions 74a, 74b are elastically displaced in the width direction outside, it is possible to prevent the clamp member 70 from slipping from the attachment portion 60.

In a case in which the holding wall portions 74a, 74b are elastically displaced in the width direction outside, the holding wall portions 75a, 75b are elastically displaced in the width direction inside such that the holding wall portions 75a, 75b are elastically deformed in the direction to approach the intervening portion 62. That is, in the case in which the holding wall portions 74a, 74b are elastically displaced in the width direction outside, the sandwiching wall portions 75a, 75b are elastically displaced in a direction in which the intervening portion 62 is more firmly sandwiched between the sandwiching wall portions 75a, 75b. Accordingly, when the holding wall portions 74a, 74b are elastically displaced in the width direction outside by the wiring 17e, the clamp member 70 enters the state of being more firmly attached to the attachment portion 60. Therefore, even if the holding wall portions 74a, 74b are elastically displaced in the width direction outside by the wiring 17e, it is possible to more suitably prevent the clamp member 70 from slipping from the attachment portion 60.

Also, according to the first embodiment, the clamp member 70 further includes the spring portions 77a, 77b that are elastically deformable in the width direction Y. At least part of the spring portions 77a, 77b is provided on the connecting wall portion 72. Therefore, by applying the force directed in the width direction inside to the holding wall portions 74a, 74b, it is possible to elastically deform the spring portions 77a, 77b in the width direction Y, and it is possible to easily elastically deform the holding wall portions 74a, 74b in the width direction inside. As a result, it is possible to attach and detach the clamp member 70 to and from the attachment portion 60 more easily.

Also, according to the first embodiment, the spring portions 77a, 77b are U-shaped when viewed in the depth direction X. Therefore, it is possible to elastically deform the spring portions 77a, 77b in the width direction Y more easily. As a result, the holding wall portions 74a, 74b can be elastically displaced in the width direction inside more easily. As a result, it is possible to attach and detach the clamp member 70 to and from the attachment portion 60 more easily.

Also, according to the first embodiment, the spring portions 77a, 77b are U-shaped opening toward the upper side when viewed in the depth direction X. Therefore, compared to the case where the spring portions 77a, 77b are U-shaped opening toward the lower side when viewed in the depth direction X, the spring portions 77a, 77b are less likely to protrude into the holding space S in which the wiring 17e is held. As a result, it is easy to secure a wider holding space S in which the wiring 17e is held. Therefore, even in the case in which the plurality of wires 17e are bundled to form the wire bundle 17d as in the first embodiment, it is suitable to hold the wire bundle 17d by the clamp member 70. Also, the force applied to the holding wall portions 74a, 74b during the elastic displacement can be distributed and received by the two spring portions 77a, 77b. Therefore, the stress generated in the spring portions 77a, 77b can be reduced, and the spring portions 77a, 77b can be less likely to wear out. Also, in the first embodiment, the pair of spring portions 77a, 77b are connected by the rib portion 72f such that the strength of the spring portions 77a, 77b can be improved. Accordingly, it is possible to further suppress the spring portions 77a, 77b from being worn out.

Also, according to the first embodiment, the plurality of spring portions 77a, 77b include the spring portion 77a configured by part of the connecting wall portion 72 and part of one side opposing wall portion 71a, and the spring portion 77b configured by part of the connecting wall portion 72 and part of the other side opposing wall portion 71b. In this manner, by providing the pair of spring portions 77a, 77b that respectively include parts of the pair of opposing wall portions 71a, 71b, it is possible to make the holding wall portions 74a, 74b to be more easily elastically displaced. Therefore, the clamp member 70 can be attached and detached to and from the attachment portion 60 more easily. Also, by using part of the opposing wall parts 71a, 71b as part of the spring portions 77a, 77b, it is possible to suppress the shape of the clamp member 70 from becoming complicated. Therefore, the clamp member 70 can be manufactured easily.

Also, according to the first embodiment, each of the holding wall portions 74a, 74b of the pair of opposing wall portions 71a, 71b includes the side wall portions 74c, 74e arranged along the height direction Z and the protruding wall portions 74d, 74f protruding from the end portions at the upper side of the side wall portions 74c, 74e to protrude toward the other holding wall portions 74a, 74b, respectively. Accordingly, it is possible to suitably suppress the wiring 17e in the holding space S from moving in the width direction Y by the side wall portions 74c, 74e while suitably suppressing the wiring 17e in the holding space S from moving to the upper side by the protruding wall portions 74d, 74f. As a result, it is possible to suitably suppress the wiring 17e held by the clamp member 70 from coming out of the holding space S.

Also, according to the first embodiment, in the tip portion of the protruding wall portion 74d, the first opposing portion 76a and the second opposing portion 76b that protrudes toward the protruding wall portion 74f in the other side holding wall portion 74b than the first opposing portion 76a and is opposite to the first opposing portion 76c of the protruding wall portion 74f in the other side holding wall portion 74b in the width direction Y are provided. Similarly, in the tip portion of the protruding wall portion 74f, the first opposing portion 76c and the second opposing portion 76d that protrudes toward the protruding wall portion 74d in the other side holding wall portion 74a than the first opposing portion 76c and is opposite to the first opposing portion 76a of the protruding wall portion 74d in the other side holding wall portion 74a in the width direction Y are provided. Accordingly, the gap between the protruding wall portions 74d, 74f in the width direction Y is relatively small by the second opposing portions 76b, 76d of each protruding wall portions 74d, 74f, and it is possible to elastically deform the holding wall portions 74a, 74b in the width direction inside until each of the second opposing portions 76b, 76d comes into contact with the first opposing portions 76a, 76c that are positioned at the width direction outside than the second opposing portions 76b, 76d. Accordingly, it is possible to makes the wiring 17e to be difficult to slip out from the gap between the protruding wall portions 74d, 74f, and increases the amount of elastic displacement of the holding wall portions 74a, 74b to increase the amount of elastic displacement of the sandwiching wall portions 75a, 75b. Accordingly, it is possible for the clamp member 70 to stably hold the wiring 17e and it is easy for the clamp member 70 to be attached to and detached from the attachment portion 60. Also, by providing the first opposing portions 76a, 76c recessed to the width direction outside than the second opposing portions 76b, 76d, it is easy to widen the gap between the protruding wall portions 74d, 74f. Therefore, it is easy to put the wiring 17e into the holding space S from the gap between the protruding wall portions 74d, 74f.

Also, according to the first embodiment, the protruding portions 76e, 76f protruding toward the lower side are provided at the tip portions of the protruding wall portions 74d, 74f. Therefore, even in the case in which the wiring 17e moves to the upper side in the holding space S, it is possible to prevent the wiring 17e from coming out from the gap between the tip portions of the protruding wall portions 74d, 74f by the protruding portions 76e, 76f. As a result, the wiring 17e can be prevented from coming out of the holding space S more effectively.

Also, according to the first embodiment, the clamp member 70 further includes the pair of support wall portions 73a, 73b that protrude from each of the pair of opposing wall portions 71a, 71b in the direction separating from the other side opposing wall portions 71a, 71b respectively. The pair of support wall portions 73a, 73b come into contact with the attachment portion 60 from the upper side. Accordingly, it is possible to prevent the clamp member 70 from moving to the lower side with respect to the attachment portion 60 by the support wall portions 73a, 73b. As a result, the wiring 17e can be more stably held by the clamp member 70.

Also, according to the first embodiment, the pair of support wall portions 73a, 73b cover at least part of each of the pair of penetrating portions 61a, 61b from the upper side. Therefore, at least part of the penetrating portions 61a, 61b can be blocked by the supporting wall portions 73a, 73b. Accordingly, it is possible to prevent foreign matter from entering the penetrating portions 61a, 61b from the upper side. Therefore, for example, in a case in which the clamp structure 50 is provided in an exterior housing that covers a certain object, it is possible to prevent the foreign matter from entering the interior of the exterior housing through the penetrating portions 61a, 61b, and it is possible to prevent the foreign matter from adhering to the certain object.

As in the first embodiment, in the case of the structure in which the sandwiching wall portions 75a, 75b are opened in the width direction outside and inserted into and removed from the penetrating portions 61a, 61b, in the state in which the clamp member 70 is attached to the attachment portion 60, the penetrating portions 61a, 61b are formed in the shape that spreads in the width direction outside from the sandwiching wall portions 75a, 75b. Therefore, by providing the support wall portions 73a, 73b that protrude in the width direction outside, it is possible to employ the configuration in which the support wall portions 73a, 73b cover substantially the entire penetrating portions 61a, 61b. For example, in the case in which the sandwiching wall portions 75a, 75b are closed in the width direction inside and inserted into and removed from one hole, the part for moving the sandwiching wall portions 75a, 75b in the width direction inside in the one hole cannot be blocked.

Also, according to the first embodiment, the clamp structure 50 is provided in the electrical component unit 17 of the outdoor unit 10. In the outdoor unit 10, the wiring 17e of the electrical component unit 17 and the object holding the wiring 17e, that is, the plate member 17c, is relatively often removed for maintenance, parts replacement, and the like. Therefore, by providing the clamp structure 50 including the easily attachable/detachable clamp member 70, the workability of the outdoor unit 10 such as the maintenance and parts replacement can be improved.

### Second Embodiment

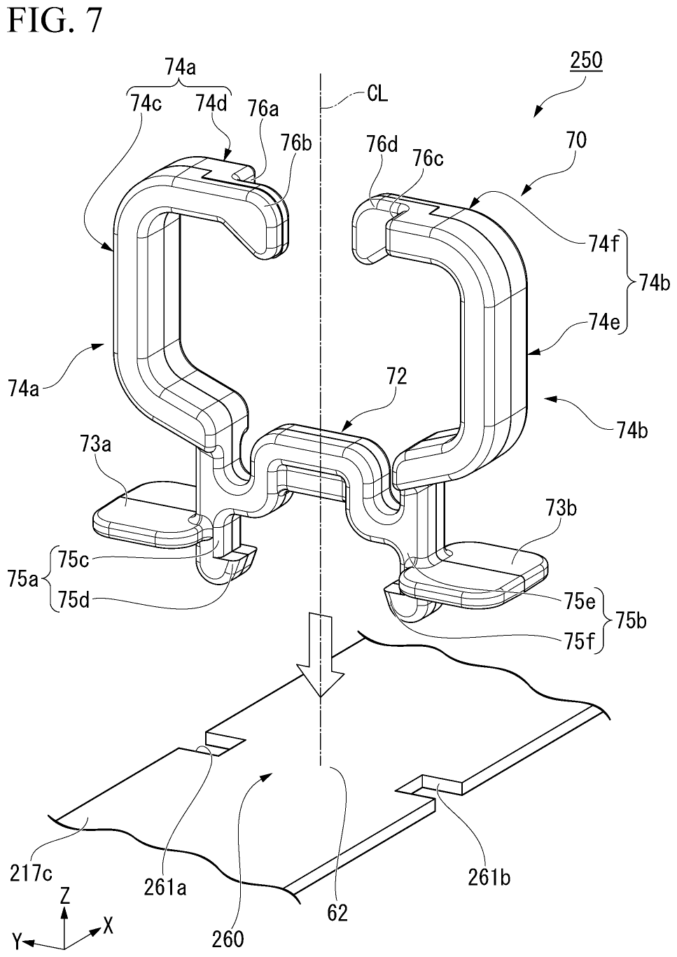

FIG. 7 is a perspective view showing a clamp structure 250 according to the second embodiment, showing a state in which the clamp member 70 is not attached to attachment portion 260. As shown in FIG. 7, the clamp structure 250 according to the second embodiment is different from the clamp structure 50 according to the first embodiment described above in the shape of an attachment portion 260. In the description of the other embodiments shown below, the description of the same configuration with that in the above-described embodiment may be appropriately omitted by assigning the same reference sign thereto.

The attachment portion 260 in the clamp structure 250 is provided on a plate member 217c. The plate member 217c has a plate shape extending in the depth direction X. The thickness direction of the plate member 217c is the height direction Z. A pair of penetrating portions 261a, 261b in the attachment portion 260 are recess portions that are recessed in the width direction inside from both end portions in the width direction of the plate member 217c. The penetrating portions 261a, 261b penetrate the plate member 217c in the height direction Z. Even if the penetrating portions 261a, 261b are formed in such a shape, it is possible to attach the clamp member 70 to the attachment portion 260 by passing the sandwiching wall portions 75a, 75b through the penetrating portions 261a, 261b, respectively and sandwiching an intervening portion 62 between the pair of sandwiching wall portions 75a, 75b. Other configurations of the clamp structure 250 are the same with the other configurations of the clamp structure 50 according to the first embodiment described above.

### Third Embodiment

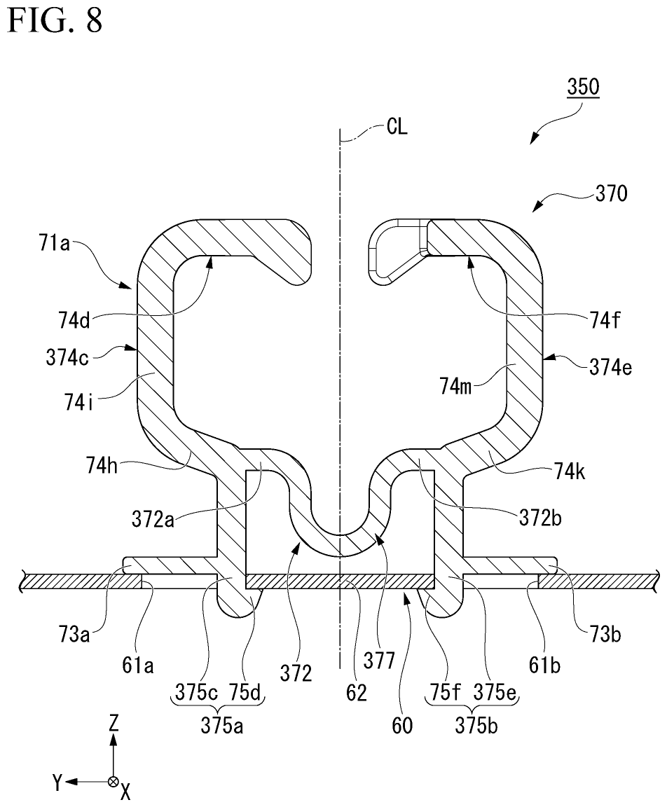

FIG. 8 is a cross-sectional view showing a clamp structure 350 according to the third embodiment, showing a state in which a clamp member 370 is attached to the attachment portion 60. As shown in FIG. 8, the clamp structure 350 according to the third embodiment is different from the clamp structure 50 according to the first embodiment described above in the shape of the clamp member 370.

A connecting wall portion 372 in the clamp member 370 has a pair of width direction outside end portions 372a, 372b and a spring portion 377. The width direction outside end portion 372a extends in the width direction inside from the end portion at the width direction inside (−Y side) of the inclined wall portion 74h. The width direction outside end portion 372b extends in the width direction inside from the end portion at the width direction inside (+Y side) of the inclined wall portion 74k.

In the third embodiment, the entire spring portion 377 is provided on the connecting wall portion 372. The spring portion 377 protrudes to the lower side from the end portions in the width direction inside of the pair of width direction outside end portions 372a, 372b. The spring portion 377 has a U-shape opening at the upper side when viewed in the depth direction X. In the third embodiment, the spring portion 377 has a shape line-symmetrical in the width direction Y with respect to the center line CL.

In the third embodiment, a sandwiching wall portion main body 375c of the sandwiching wall portion 375a extends to the lower side from the end portion at the width direction inside (−Y side) of the inclined wall portion 74h. A sandwiching wall portion main body 375e of the sandwiching wall portion 375b extends to the lower side from the end portion at the width direction inside (+Y side) of the inclined wall portion 74k. The side wall portion 374c according to the third embodiment is configured of the outer extending wall portion 74i and the inclined wall portion 74h. The side wall portion 374e is configured of the outer extending wall portion 74m and the inclined wall portion 74k. Other configurations of the clamp structure 350 are the same with the other configurations of the clamp structure 50 according to the first embodiment.

According to the third embodiment, only one spring portion 377 is provided. Therefore, the dimension of the spring portion 377 in the width direction Y can be increased compared to the case where two spring portions 377 are provided. Therefore, for example, in a case in which the U-shaped spring portion 377 according to the third embodiment is manufactured by the injection molding using a mold, it is easy to make the portion of the mold that forms the opening of the U-shaped spring portion 377 to be thick. This facilitates improving the durability of the mold for manufacturing the clamp member 370. Therefore, it is easy to reduce the production cost of the clamp member 370.

### Fourth Embodiment

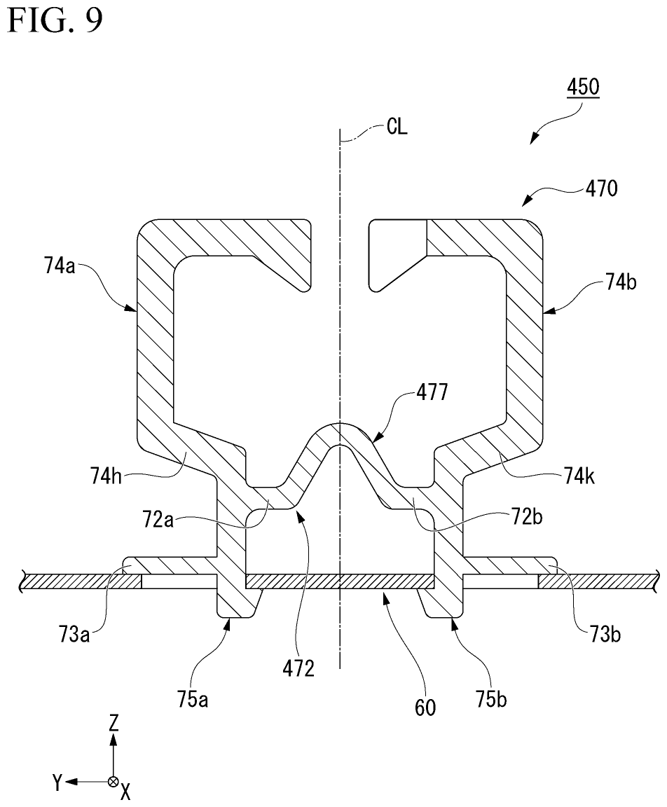

FIG. 9 is a cross-sectional view showing a clamp structure 450 according to the fourth embodiment, showing a state in which a clamp member 470 is attached to the attachment portion 60. As shown in FIG. 9, the clamp structure 450 according to the fourth embodiment is different from the clamp structure 50 according to the first embodiment described above in the shape of the clamp member 470.

A connecting wall portion 472 of the clamp member 470 has the pair of width direction outside end portions 72a, 72b and a spring portion 477. In the fourth embodiment, the entire spring portion 477 is provided on the connecting wall portion 472. The spring portion 477 protrudes to the upper side from the end portions in the width direction inner side of the pair of width direction outside end portions 72a, 72b. The spring portion 477 has a V-shape opening to the lower side when viewed in the depth direction X. The spring portion 477 may have the U-shape opening to the lower side when viewed in the depth direction X. In the fourth embodiment, the spring portion 477 has a shape line-symmetrical in the width direction Y with respect to the center line CL. An end portion at the upper side of the spring portion 477 protrudes to the upper side than the inclined wall portions 74h, 74k. Other configurations of the clamp structure 450 are the same with the other configurations of the clamp structure 50 according to the first embodiment.

### Fifth Embodiment

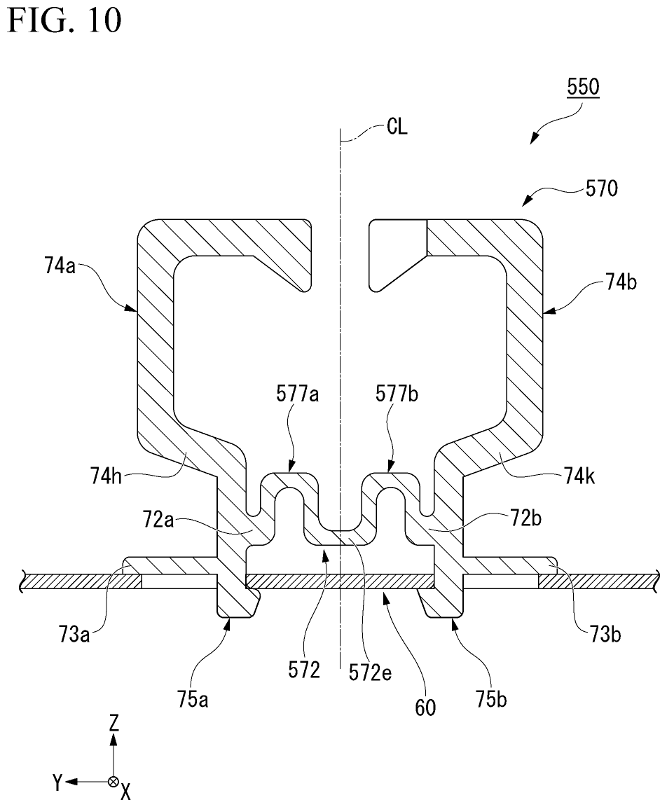

FIG. 10 is a cross-sectional view showing a clamp structure 550 according to the fifth embodiment, showing a state in which a clamp member 570 is attached to the attachment portion 60. As shown in FIG. 10, the clamp structure 550 according to the fifth embodiment is different from the clamp structure 50 according to the first embodiment described above in the shape of the clamp member 570.

The connecting wall portion 572 of the clamp member 570 has the pair of width direction outside end portions 72a, 72b, a pair of spring portions 577a, 577b, and a central portion 572e. In the fifth embodiment, the entire spring portions 577a, 577b are provided on the connecting wall portion 572. The spring portion 577a and the spring portion 577b are arranged side by side in the width direction Y. The spring portion 577a and the spring portion 577b have a U-shape opening to the lower side when viewed in the depth direction X. The end portion at the upper side of the spring portion 577a and the end portion at the upper side of the spring portion 577b are positioned at the lower side of the end portions at the upper side of the inclined wall portions 74h, 74k.

The end portion at the lower side in the portion at the width direction inside (−Y side) of the spring portion 577a and the end portion at the lower side in the portion at the width direction inside (+Y side) of the spring portion 577b extend in the width direction Y and are connected by the central portion 572e. The end portion at the lower side in the portion at the width direction outside (+Y side) of the spring portion 577a is connected with the end portion at the width direction inside of the width direction outside end portion 72a. The end portion at the lower side in the portion at the width direction outside (−Y side) of the spring portion 577b is connected with the end portion at the width direction inside of the width direction outside end portion 72b. Other configurations of the clamp structure 550 are the same with the other configurations of the clamp structure 50 according to the first embodiment.

Although the embodiments of the present disclosure have been described above, the present disclosure is not limited to the configurations of the embodiments described above, and the following configurations and methods can also be adopted.

The shape of the clamp member only has to include the pair of opposing wall portions to have the holding wall portion and the sandwiching wall portion and the connecting wall portion for connecting the pair of opposing wall portions, and may be any shape. The shape of the pair of holding wall portions only has to be able to surround the wirings by the connecting wall portion and the pair of holding wall portions, and may be any shape. The holding wall portion may be a shape extending in an arc.

The first opposing portion and the second opposing portion may not be provided in the protruding wall portion, and the protruding portion may not be provided in the protruding wall portion. The connecting wall portion only has to be formed such that each holding wall portion and each sandwiching wall portion are elastically displaceable and may be any shape.

The spring portion provided in the clamp member only has to be elastically deformable in the second direction (width direction Y), and may be any shape. The spring portion may be a leaf spring linearly extending in the second direction. In this case, the spring portion may be elastically deformed in the second direction by buckling in the first direction (height direction Z). Also, in this case, the spring portion may configure the entire connecting wall portion for connecting the pair of opposing wall portions. The number of the spring portions is not particularly limited. A plurality of spring portions may be provided as in the first, second, and fifth embodiments described above, or only one spring portion may be provided as in the third and fourth embodiments described above. The spring portions may be provided to be equal to or more than three. If the holding wall portions of the pair of opposing wall portions can be elastically displaced in the direction to approach each other and the sandwiching wall portions of the pair of opposing wall portions can be elastically displaced in the direction to approach each other, the spring portion may not be provided.

The clamp structure may be provided to any member. For example, the clamp structure may be provided in the partitioning wall portion 11c in the outdoor unit 10 according to the above-described first embodiment, may be provided in the outdoor unit housing 11, may be provided in the housing 17a of the electrical component unit 17, and may be provided in the indoor unit 20. The clamp structure may be provided in a device other than the refrigeration cycle device. The number of the wirings that are held by the clamp structure is not particularly limited. The refrigeration cycle device is not limited to the air conditioner as long as the refrigeration cycle device utilizes the refrigeration cycle in which the refrigerant circulates. The refrigeration cycle device may be a heat pump water heater or the like. As described above, each configuration and each method described in this specification can be appropriately combined as long as they do not contradict each other.

1. A clamp member attached to an attachment portion to hold a wiring with respect to an object, wherein the attachment portion includes a pair of penetrating portions that penetrate the object in a predetermined first direction and arranged in a second direction orthogonal to the first direction to be separated from each other with a gap, the clamp member comprising:
a pair of opposing wall portions that are arranged to be separated from each other with a gap and opposite to each other in the second direction;
a connecting wall portion that connects the pair of opposing wall portions; and
a pair of support wall portions that protrude in a direction to be separated from the other opposing wall portion from each of the pair of opposing wall portions,
wherein each of the pair of opposing wall portions includes
a holding wall portion that protrudes to a first side in the first direction with respect to the connecting wall portion; and
a sandwiching wall portion that protrudes to a second side in the first direction with respect to the connecting wall portion,
the wiring is surrounded by the holding wall portions of the pair of opposing wall portions and the connecting wall portion,
the sandwiching wall portions of the pair of opposing wall portions are passed through the pair of penetrating portions respectively to sandwich an intervening portion positioned between the pair of penetrating portions in the attachment portion in the second direction, and each of the sandwiching wall portions of the pair of opposing wall portions includes a claw portion that protrudes toward the sandwiching wall portion at the other side to be caught on the intervening portion from the second side,
the holding wall portions of the pair of opposing wall portions are elastically displaceable in a direction to approach each other,
the sandwiching wall portions of the pair of opposing wall portions elastically displace in a direction to be separated from each other when the holding wall portions of the pair of opposing wall portions are elastically displaced in the direction to approach each other, and
the pair of support wall portions come into contact with the attachment portion from the first side.

2. The clamp member according to claim 1, further comprises a spring portion that is elastically deformable in the second direction, wherein at least part of the spring portion is provided in the connecting wall portion.

3. The clamp member according to claim 2, wherein the spring portion has a U-shape when viewed in a third direction orthogonal to both the first direction and the second direction.

4. The clamp member according to claim 3, wherein the spring portion has the U-shape opening at the first side when viewed in the third direction.

5. The clamp member according to claim 3,
wherein a plurality of spring portions are provided, and
the plurality of the spring portions include
the spring portion that is configured of part of the connecting wall portion and part of either opposing wall portion of the pair of opposing wall portions; and
the spring portion that is configured of part of the connecting wall portion and part of the other opposing wall portion of the pair of opposing wall portions.

6. The clamp member according to claim 1,
wherein each of the holding wall portions of the pair of opposing wall portions includes
a side wall portion arranged along the first direction; and
a protruding wall portion that protrudes toward the other holding wall portion from an end portion at the first side of the side wall portion.

7. The clamp member according to claim 6,
wherein a tip portion of the protruding wall portion includes
a first opposing portion; and
a second opposing portion protrudes to the protruding wall portion in the other holding wall portion with respect to the first opposing portion, and is opposite to the first opposing portion of the protruding wall portion in the other holding wall portion in the second direction.

8. The clamp member according to claim 6, wherein a protruding portion that protrudes to the second side is provided in a tip portion of the protruding wall portion.

9. (canceled)

10. The clamp member according to claim 1, wherein the pair of support wall portions cover at least part of the pair of penetrating portions from the first side respectively.

11. A clamp structure, comprising:
the clamp member according to claim 1, and
the attachment portion.

12. A refrigeration cycle device, comprising the clamp structure according to claim 11.

13. The refrigeration cycle device according to claim 12, comprising an outdoor unit including an electrical component unit having the wiring, wherein the clamp structure is provided in the electrical component unit.
